(19) United States
(12) Patent Application Publication
(10) Pub. No.: US 2020/0214259 A1
(43) Pub. Date: Jul. 9, 2020

(54) ANIMAL CONTROL APPARATUS

(71) Applicant: Erik Keith Johnson, Rexford, MT (US)

(72) Inventor: Erik Keith Johnson, Rexford, MT (US)

(21) Appl. No.: 16/733,595

(22) Filed: Jan. 3, 2020

Related U.S. Application Data
(60) Provisional application No. 62/917,885, filed on Jan. 7, 2019.

(51) Int. Cl. A01K 27/00; A41F 9/00

(52) U.S. Cl. CPC A01K 27/003; A41F 9/002

(57) ABSTRACT

An animal control apparatus includes a belt to be removably secured about the midsection of a user and a strap attached to the belt at first and second attachment locations on an outside surface of the belt such that a portion of the strap extends along a portion of the outside surface of the belt between the first and second attachment locations. Spacing the first attachment location from the second attachment location creates a loop between the portion of the belt and the portion of the strap. The loop may receive a linking device attached to a lead of an animal such that the user of the apparatus may control the animal in a hands-free manner while allowing the animal a degree of freedom as a result of the linking device sliding along the strap between the first and second attachment locations of the loop.

### CROSS-REFERENCE TO RELATED APPLICATIONS

This patent application claims the benefit under 35 U.S.C. § 119(e) of U.S. Provisional Application No. 62/917,885, entitled K-9 KONECT, filed Jan. 7, 2019, which is hereby incorporated by reference in its entirety.

### TECHNICAL FIELD

The present application relates to the field of animal control apparatuses.

### BRIEF DESCRIPTION OF THE SEVERAL VIEWS OF THE DRAWINGS

FIG. 1 illustrates a scenario including the use of an animal control apparatus in accordance with one embodiment.

FIG. 2A and FIG. 2B together illustrate a front view and a back view of an animal control apparatus in accordance with one embodiment.

FIG. 3 illustrates an animal control apparatus in accordance with one embodiment.

FIG. 4 illustrates an animal control apparatus in accordance with one embodiment.

FIG. 5 illustrates an animal control apparatus in accordance with one embodiment.

FIG. 6 illustrates a portion of an animal control apparatus in use with an associated tactical mount, in accordance with one embodiment.

FIG. 7 illustrates a method for using an animal control apparatus, according to an embodiment.

### DETAILED DESCRIPTION

It is not uncommon for a person to have a need to control an animal's location relative to the person and/or the distance from the animal to the person while both the person and the animal are in motion. For example, a dog owner may wish to take their dog on a walk, but may have a need to keep the animal within a set distance, or certain area near and/or distance from the person. This may be particularly useful in public situations where such control of the animal is expected (e.g., due to societal norms) and/or required (e.g., due to local rules or ordinances regarding animals).

However, maintaining this type/level of control over an animal often comes at a certain physical cost to the person controlling the animal. For example, it may be that a person may want to effectively control an animal while leaving both hands free to perform other actions. This may not be properly accomplished with a typical lead, because the person must always use at least one hand to hold the lead. In some circumstances, a person may wish to control multiple (e.g., two, five, seven, etc.) animals simultaneously. This is difficult when using leads held in the hand for each of the animals, because the person's hands may quickly become full. In some circumstances, a person may wish to control an animal that is particularly strong. This can be problematic when using a lead held in the hand, because the animal may be capable of pulling the lead out of the hand of the person. Even in cases where the person hangs on, a strong animal (or multiple animals pulling together) may be able to pull the person against their will (e.g., by leveraging the distance between the shoulder of the user and the user's center of mass against the user).

There is, accordingly, a need for an improved apparatus that allows a single person to more effectively control one or more animals and/or animals of high strength in a hands-free manner. The animal control apparatuses described herein act to overcome at least the above-discussed disadvantages.

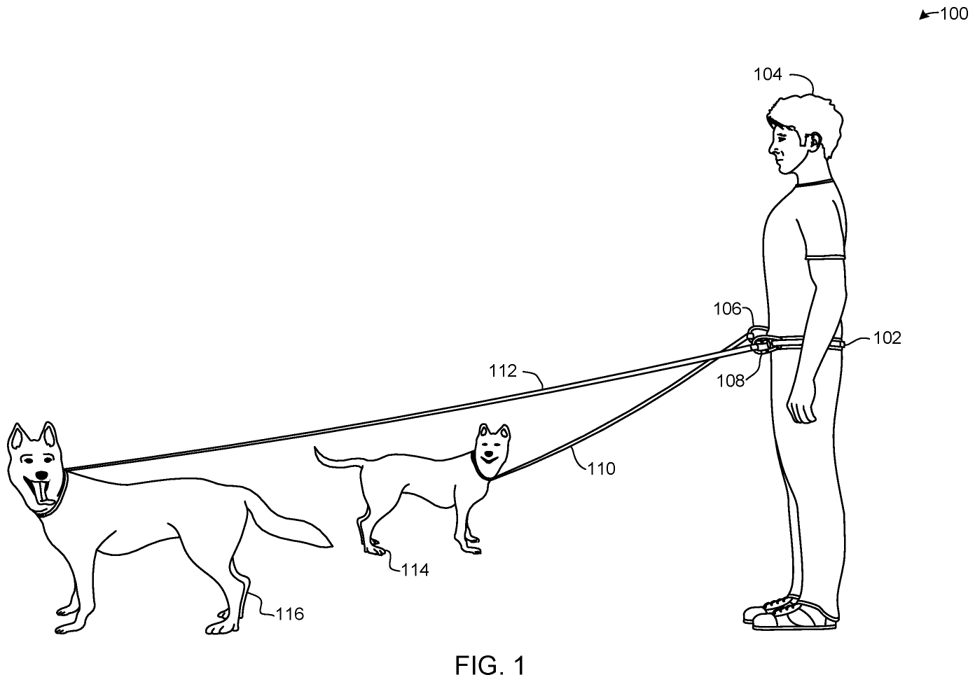

FIG. 1 illustrates a scenario 100 including the use of an animal control apparatus 102 in accordance with one embodiment. In the scenario 100, the animal control apparatus 102 has been placed around the midsection of a user 104. As shown, it is contemplated that the animal control apparatus 102 may be worn by the user 104 on the outside of the clothing.

Each of a first linking device 106 and a second linking device 108 may be connected to the animal control apparatus 102 at one or more loops of the animal control apparatus 102 (which will be discussed in additional detail below). Each of the first linking device 106 and the second linking device 108 may be respectively attached to a first lead 110 and a second lead 112, which may in turn be respectively attached to a first animal 114 and a second animal 116.

This arrangement may allow the user 104 to generally control the location of the first animal 114 and the second animal 116 simply by remaining aware of their own location and taking into account the length of the first lead 110 and the second lead 112. Further, this has been accomplished without the user 104 using either hand to hold onto either of the first lead 110 or the second lead 112 (due to the attachment of these to one or more loops of the animal control apparatus 102 via, respectively, the first linking device 106 and the second linking device 108). The first animal 114 and the second animal 116 are more securely held in this arrangement as compared to in-hand leads due to the fact that breaking loose would require said animal to pull hard enough to break one of the lead 110, 112, the linking device 106, 108, or the animal control apparatus 102 (as opposed to merely pulling a lead out of a hand of a user). Finally, the placement of the animal control apparatus 102 at the midsection of the user 104 (near the center of mass of the user 104) means that the user 104 can more effectively use their own weight against any pulling of either of the first animal 114 and/or the second animal 116, making it easier for the user 104 to control the placement of the animals 114, 116 than would otherwise be possible with in-hand leads. As shown, the hands of the user 104 are not being used to control, for example, the leads 110, 112 attached to the animals 114, 116, and thus the user 104 is free to use their hands for other tasks while still controlling the animals 114, 116 via the animal control apparatus 102.

While the first animal 114 and the second animal 116 have been illustrated as dogs in FIG. 1, it is anticipated that any other animal that is capable of being similarly controlled by the animal control apparatus 102 may be used with the animal control apparatus 102 (e.g., cats, rodents, etc.). Further, while the scenario 100 has been illustrated as using two animals (the first animal 114 and the second animal 116), it is anticipated that other numbers of animals (one, three, seven, etc.) may be attached at once to the animal control apparatus 102. In some cases, this may mean that the user 104 is capable of controlling more animals than would otherwise be possible (e.g., when holding animal leads in their hands).

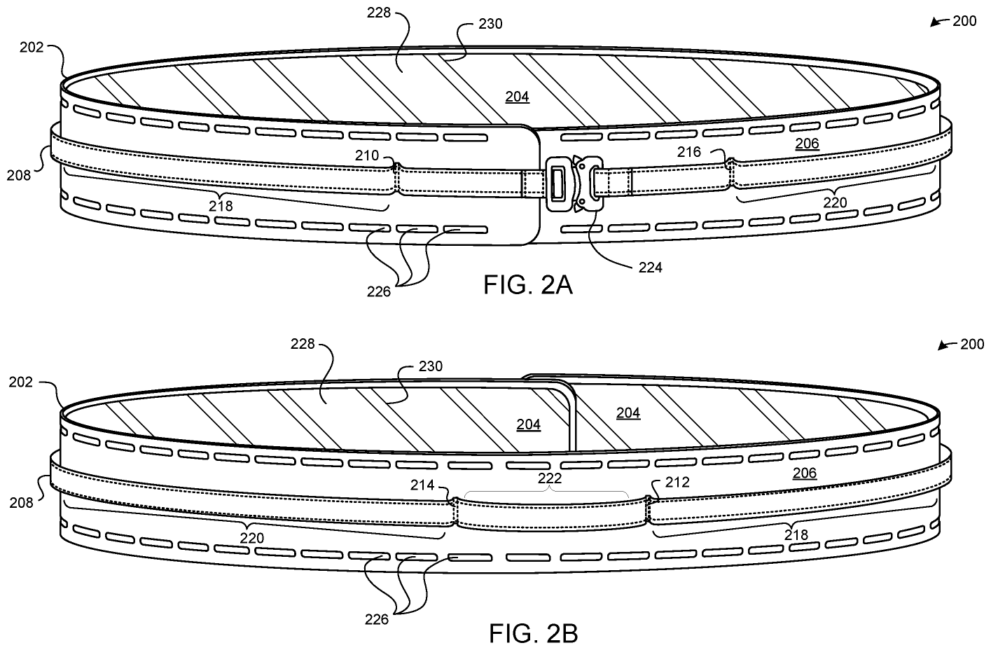

FIG. 2A and FIG. 2B together illustrate a front view and a back view of an animal control apparatus 200 in accordance with one embodiment. The animal control apparatus 200 includes a belt 202. The belt 202 may be removably secured about the midsection of a user (as shown in, e.g., FIG. 1). The belt 202 may be worn on the outside of a user's clothing. The belt 202 may be made of one or more types of appropriate material. By way of example, the belt 202 may include materials such as leather, cloth (such as polyester, cotton, etc.), rubber, plastic, memory foam, etc. As will be further discussed below, the belt 202 may be constructed of more than one layer of materials. The belt 202 includes an inside surface 204 which may rest against a midsection of a user when the animal control apparatus 200 is worn. The belt 202 further includes an outside surface 206 to which other items (e.g., a strap 208) may be attached (as further described below).

The animal control apparatus 200 further includes a strap 208. The strap 208 may be attached to the belt 202 at a plurality of attachment locations (for example, one or more of a first attachment location 210, a second attachment location 212, a third attachment location 214, and a fourth attachment location 216). The attachment of the strap 208 to the belt 202 at the attachment locations 210, 212, 214, 216 may be performed with stitching, glue, melting at the attachment point, etc. It is further contemplated that in some embodiments, the belt 202 and the strap 208 may be created together as a single item (e.g., using a plastic mold that builds the belt 202 and the strap 208 together as a single item). Similarly to the belt 202, the strap 208 may include materials such as leather, cloth (such as polyester, cotton, etc.), rubber, plastic, memory foam, etc. Like the belt 202, the strap 208 may also be constructed of more than one layer of materials.

As shown, the attachment locations 210, 212, 214, 216 may be spaced apart from one another. Accordingly, the attachment of the strap 208 at one or more of the attachment locations 210, 212, 214, 216 may cause the strap 208 to extend along the outside surface 206 of the belt 202 between one or more of the attachment locations 210, 212, 214, and 216. The attachment of the strap 208 at the attachment locations 210, 212, 214, and 216 creates a first loop 218 between the first attachment location 210 and the second attachment location 212, a second loop 220 between third attachment location 214 and the fourth attachment location 216, and a third loop 222 between the second attachment location 212 and the third attachment location 214, with each of these loops 218, 220, 222 comprising the extensions of the portion of the strap 208 and the portion of the belt 202 between the associated attachment locations 210, 212, 214, 216.

Each of the first loop 218, second loop 220, and third loop 222 may be configured to receive one or more linking devices (e.g., the first linking device 106 and/or the second linking device 108 of FIG. 1) useful to link, for example, a lead of an animal to be controlled to a loop 218, 220, 222 of the animal control apparatus 200. Examples of linking devices that may be used include carabiners (see, e.g., FIG. 1), rings, or the like. A lead of an animal may be attached to the animal and then attached to the linking device. The linking device may then be interfaced with a loop 218, 220, 222 of the animal control apparatus 200 such that said linking device may slide along the portion of the strap 208 that extends between the attachment locations 210, 212, 214, 216 associated with the given loop. This sliding may be according to the movement of the animal parallel to the extension of this portion of the strap 208 along the associated portion of the outside surface 206 of the belt 202. It is contemplated that in some embodiments a linking device as herein described may be pre-affixed to or pre-integrated into a lead. It is also contemplated that in some cases a lead may be modified to incorporate the relevant features of a linking device as those features are herein detailed. It is anticipated that more than one animal, each with its own lead and linking device, may be attached to any one of the loops 218, 220, 222 of the animal control apparatus 200. This may be useful in cases where a user has a large number of animals, or a very large and/or strong animal, that must be controlled.

The locations of the attachment locations 210, 212, 214, 216 associated with a loop of the animal control apparatus 200 may act to help tend an animal toward certain areas relative to the directionality of a user of the animal control apparatus 200. For example, an animal attached via a lead and a linking device to the first loop 218 may tend to remain on the user's right side, as that animal naturally intuits over time and through experience that remaining on that side will give it the greatest degree of freedom (due to the fact that the linking device will be interfered with by one of the first attachment location 210 and the second attachment location 212 once the animal leaves the user's right side and will no longer slide). Similarly, an animal attached via a lead and a linking device to the second loop 220 may intuitively tend to remain on the user's left side. In this way, the user can generally balance or otherwise determine the location of the animal(s) relative to the user's directionality.

When connected with the animal control apparatus 200 in such a manner, the animal may be constrained from traveling a distance from the user that is greater than the length of the lead and any linking device attached to the lead. When an animal reaches this point, a stationary force relative to the movement of the first animal perpendicular to the extension of the portion of the strap 208 associated with the loop to which the animal is connected begins to be applied to the animal lead via the lead and the linking device by nature of the attachment of the strap 208 to the belt 202 (which is being worn by the user). As discussed above, in order to overcome this stationary force (outside of outright dragging the user's entire body weight), the animal would have to overcome (break) one of the lead, the linking device, and/or the animal control apparatus 200.

A distance between attachment locations 210, 212, 214, 216 associated with a loop relative to the length of the belt 202 may act to define the range of sliding motion available to an animal attached via a lead and a linking device to the loop. For example, FIG. 2A and FIG. 2B taken together illustrate that the distance between the first attachment location 210 and the second attachment location 212 associated with the first loop 218 is more than one-quarter and less than one-half of the length of the belt 202. This allows an animal attached to the first loop 218 a degree of freedom while still helping the animal tend toward remaining on the user's right side. Similarly, the distance between the third attachment location 214 and the fourth attachment location 216 associated with the second loop 220 is also more than one-quarter and less than one-half of the length of the belt 202, which may give the animal attached to the second loop 220 a degree of freedom while still helping the animal tend toward remaining on the user's left side. In the embodiment of FIGS. 2A and 2B, the distance between the second attachment location 212 and the third attachment location 214 associated with the third loop 222 is illustrated as being less than one-quarter of the length of the belt 202. This lesser distance may give an animal a lesser degree of freedom than the animal(s) attached to the first loop 218 and/or the second loop 220. Attaching an animal to a relatively small loop such as the third loop 222 may be helpful in the case that, for example, an animal is being unruly or disobedient and needs to have its motion relatively more constrained.

The number of attachment locations attaching a strap to a belt of an animal control apparatus may vary based on the number of loops desired. While FIGS. 2A and 2B have illustrated four attachment locations 210, 212, 214, and 216, resulting in three loops 218, 220, and 222 between them, it is anticipated that two, three, five, seven, 11, or another number of attachment locations may be used (along with associated distances between them, which may be varied relative to the size of the belt 202 and need not be uniform) to achieve the number and size of loops to be included in an animal control device. Decisions regarding the number of and the distances between these attachment locations may take into account considerations for associated loop size analogous to those outlined above.

The strap 208 of the animal control apparatus 200 may incorporate a buckle 224. The two halves of the buckle 224 may be respectively attached at the two end portions of the strap 208, which, because of the attachment of the strap 208 to the belt 202, may substantially align with the end portion of the belt 202. A user of the animal control apparatus 200 may release the buckle 224 in order to open up the animal control apparatus 200 and place the belt 202 of the animal control apparatus 200 at their midsection. By re-engaging the buckle 224, the user may secure the animal control apparatus 200 at their midsection. The location of one and/or both halves of the buckle 224 to its respective end portion of the strap 208 may be adjustable (e.g., by pulling an end portion of the strap 208 along the interface of such end portion and the associated half of the buckle 224) in such a way that the effective length of the strap 208 may be lengthened or shortened (thus modifying the effective size of the belt 202 and the overall effective size of the animal control apparatus 200). This may allow for the use of the animal control apparatus 200 with multiple users with different midsection sizes. Attachment mechanisms for attaching together the end portions of the strap 208 other than buckles, which are similarly adjustable (e.g., hook and loop arrangements, tying the end portions of the strap 208 together, etc.), are contemplated.

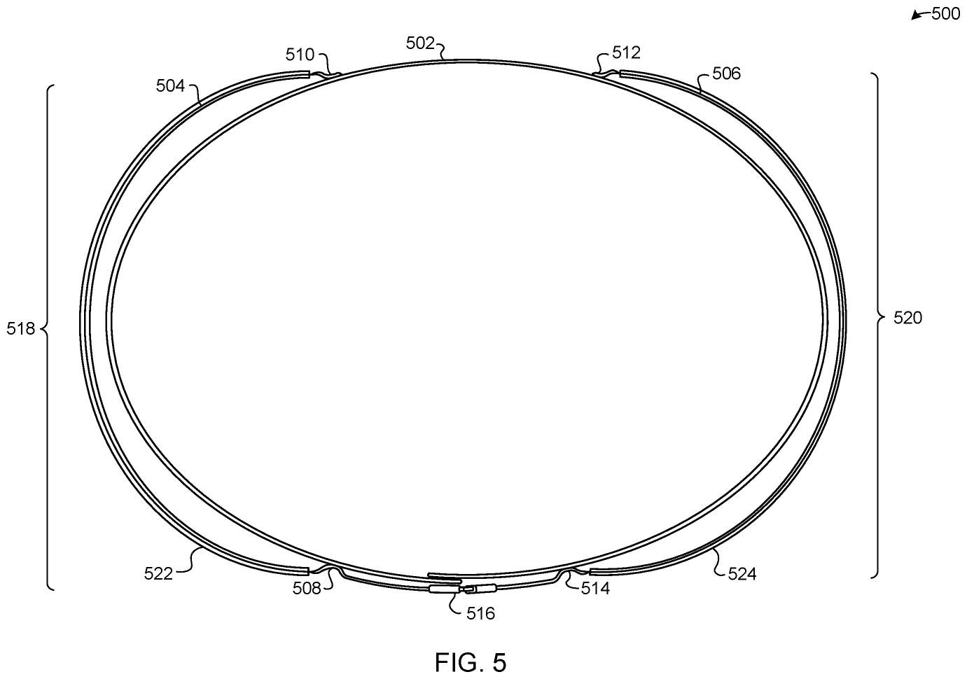

It is further anticipated that instead of using a single strap, an animal control apparatus may use multiple smaller straps. An example of this is given in relation to FIG. 5

The belt 202 of the animal control apparatus 200 may include one or more slots 226. These slots 226 may pass through one or more layers of the belt 202 (to be described in further detail below). These slots 226 may be accessible at the outside surface 206 of the belt 202. These slots 226 may be configured to receive one or more items that may be useful to be located at the waist of a user, such as, e.g., a tactical mount, a cellular telephone or smartphone, camping/hiking equipment, or another useful device. These devices may interface with one or more of the slots 226 by, for example, clipping into the belt 202 via the slots 226. An example of this is described below in relation to FIG. 5.

The inside surface 204 of the belt 202 of the animal control apparatus 200 may comprise a memory foam layer 228 of the belt 202. This memory foam layer 228 may be positioned against the waist of the user when the animal control apparatus 200 is worn, which may aid in the comfort of the user wearing the belt 202 versus a harder and/or rougher material (e.g., leather and/or cloth). The memory foam layer 228 may further include a venting feature 230, which may comprise one or more insets into the memory foam layer 228 to allow air to flow between the belt 202 and the midsection of a user. This may aid the breathability of the belt 202 and help prevent the user of the animal control apparatus 200 from becoming uncomfortable (e.g., by reducing or eliminating perspiration at the user's midsection). In the embodiment of FIG. 2, the venting feature 230 is a parallel venting feature.

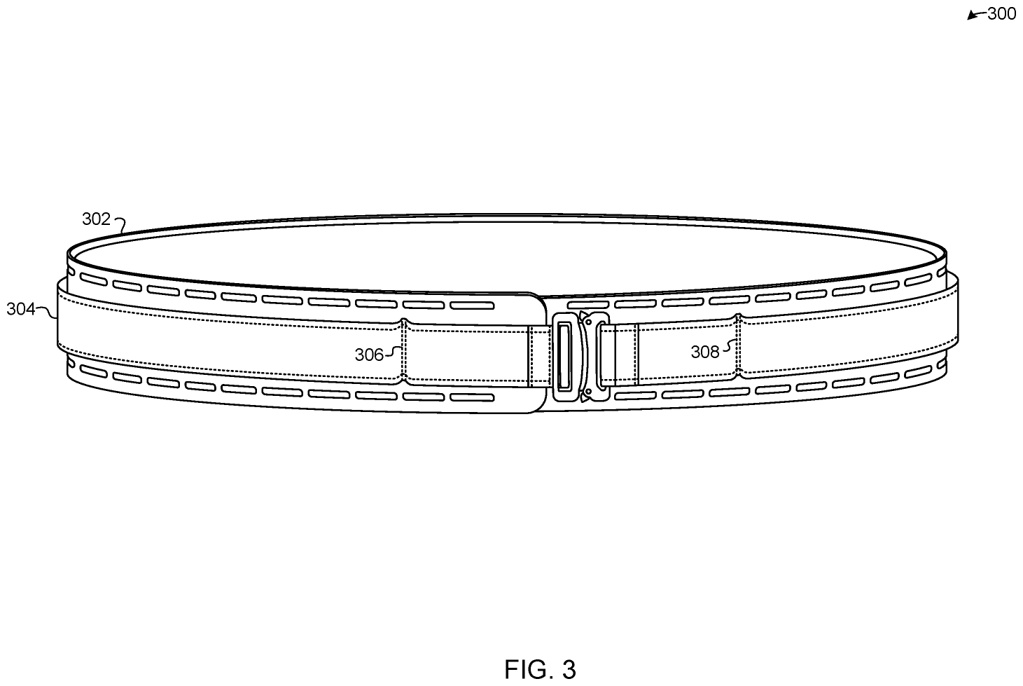

FIG. 3 illustrates an animal control apparatus 300 in accordance with one embodiment. The animal control apparatus 300 includes a belt 302 and a strap 304. However, in FIG. 3, the width of the strap 304 has been increased (relative to the width of the strap 208 in the embodiment of FIG. 2) to be more than one-third of the width of the belt 302. Increasing the width of the strap 304 may have the effect of making the animal control apparatus 300 more heavy-duty than, e.g., the animal control apparatus 200. It may be that the animal control apparatus 300 may be more successfully used (without being damaged) with larger animals or a greater number of animals. This may be due to the additional strength of the wider strap 304 and or the greater overall strength of the (larger) attachments at the attachment locations (e.g., a first attachment location 306 and a fourth attachment location 308 (with second and third attachment locations similarly arranged on the portion of the animal control apparatus 300 not illustrated in FIG. 3)) between the belt 302 and the strap 304 of the animal control apparatus 300. However, the tradeoff may be that the animal control apparatus 300 is heaver (and therefore harder to use) than the animal control apparatus 200.

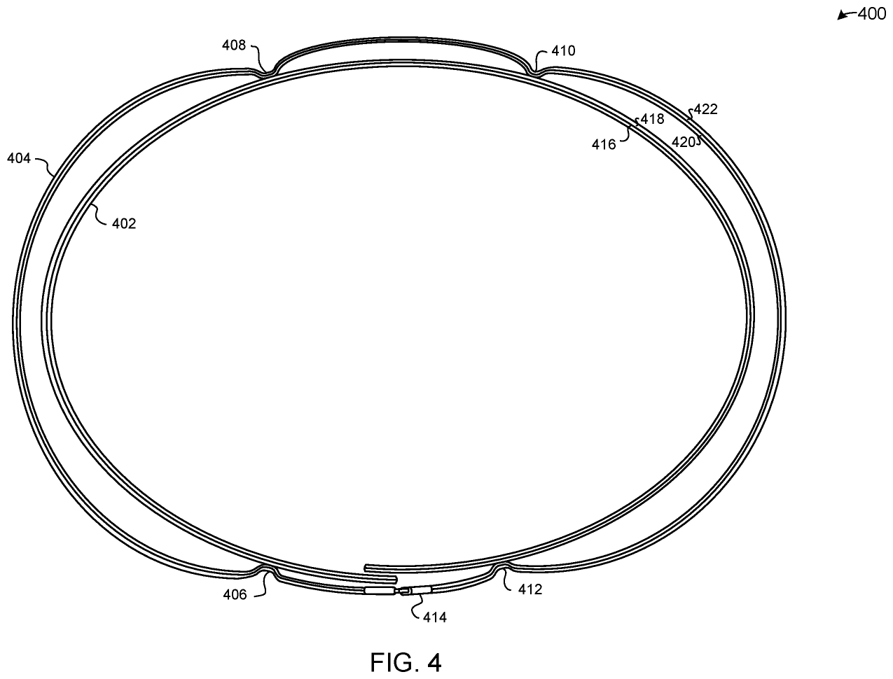

FIG. 4 illustrates an animal control apparatus 400 in accordance with one embodiment. The animal control apparatus 400 includes the belt 402 and the strap 404. The strap 404 is attached to the belt 402 at a first attachment location 406, second attachment location 408, third attachment location 410, and fourth attachment location 412. The animal control apparatus 400 further includes a buckle 414 attached to the strap 404.

As discussed above, a belt of an animal control apparatus may include (e.g., be constructed of) multiple layers. In the embodiment of FIG. 4, the belt 402 is comprised of a first belt layer 416 and a second belt layer 418. It may be that, as described above, each of the belt layers 416, 418 may be made of leather, cloth (such as polyester, cotton, etc.), rubber, plastic, memory foam, or another appropriate material. It may be that in some cases the first belt layer 416 and the second belt layer 418 are made of different materials in order to achieve a different benefit corresponding to each material. For example, it may be that the first belt layer 416 is made of memory foam in order to support the comfort of the user while the animal control apparatus 400 is located at a midsection of a user, while the second belt layer 418 is made of leather in order to give strength to the belt 402 and provide an appropriately strong surface for, e.g., the attachment of the strap 404 to the belt 402 at the attachment locations 406, 408, 410, and 412. The use of multiple layers in this way may increase the durability of the belt 402 generally over single-layer embodiments. It is anticipated a belt of an animal control apparatus may include one, two, three, five, or any other number of layers, and that one through all of these layers may give the belt specific desirable attributes associated with the material of the given layer.

As discussed above, a strap of an animal control apparatus may include (e.g., be constructed of) multiple layers. In the embodiment of FIG. 4, the strap 404 is comprised of a first strap layer 420 and a second strap layer 422. It may be that, as described above, each of the strap layers 420, 422 may be made of leather, cloth (such as polyester, cotton, etc.), rubber, plastic, memory foam, or another appropriate material. It may be in some cases that the first strap layer 420 and the second strap layer 422 are made of different materials in order to achieve a different benefit corresponding to each material. For example, it may be that the first strap layer 420 is made of durable rubber in order to provide durability to the strap 404 in light of the fact that an animal may be pulling against it, while the second strap layer 422 may be made of polyester or leather to give the outside of the strap 404 an aesthetic look. The use of multiple layers in this way may increase the durability of the strap 404 generally over single-layer embodiments. It is anticipated a strap of an animal control apparatus may include one, two, three, five, or any other number of layers, and that one through all of these layers may give the strap specific desirable attributes associated with the material of the given layer.

FIG. 5 illustrates an animal control apparatus 500 in accordance with one embodiment. The animal control apparatus 500 includes a belt 502, a first strap 504, and a second strap 506. The first strap 504 is attached to the belt 502 at a first attachment location 508 and a second attachment location 510. The second strap 506 is attached to the belt 502 at a third attachment location 512 and a fourth attachment location 514. The animal control apparatus 500 further includes a buckle 516, with the halves of the buckle 516 respectively attached to an end portion of the first strap 504 and an end portion of the second strap 506.

As illustrated, the multiple straps 504, 506 have been included in the animal control apparatus 500. Each of the first strap 504 and the second strap 506 extends along a portion of the outside surface of the belt 502 and between its associated attachment locations (with the first strap 504 associated with the first attachment location 508 and the second attachment location 510 and the second strap 506 associated with the third attachment location 512 and the fourth attachment location 514) in order to form, respectively, a first loop 518 and a second loop 520. The principle of operation of these straps 504, 506 and their associated loops 518, 520 is similar to the principle of operation relative to the single strap (and its associated loops) in embodiments of animal control apparatuses that have heretofore been explained. Either of the loops 518, 520 may be sized appropriately (via placement of their related attachment locations between the belt 502 and the relevant strap 504, 506) in order to achieve the desired animal control characteristics as described above. Further, either of the straps 504, 506 may be made of one or multiple layers, as described above. In other embodiments using multiple straps, additional and/or different attachment locations beyond the attachment locations shown in the embodiment of FIG. 5 may be used to incorporate multiple loops into a single strap. It is further contemplated that multiple straps of an animal control apparatus may share a single attachment location (e.g., via overlap).

The use of multiple straps 504, 506 (rather than a single strap spanning substantially the entire operative area of the belt 502) may simplify the assembly of the animal control apparatus 500. Further, it may allow for the use of different materials (and thus achieve different characteristics) for the first strap 504 from the second strap 506. While the animal control apparatus 500 has been illustrated with two straps 504, 506, it is anticipated that other embodiments of an animal control apparatus may include three, four, seven, or any other number of straps.

FIG. 5 further illustrates that portions of each of the first strap 504 and the second strap 506 have been covered, respectively, in a first sleeving 522 and a second sleeving 524. It may be that in some cases, the sleeving (e.g., either of the first sleeving 522 and/or the second sleeving 524) only partially covers its related strap (e.g., the first strap 504 and/or the second strap 506). The sleeving of all or part of the strap portions of one or more of the loops 518, 520 of the animal control apparatus 500 may improve the characteristics of the animal control apparatus 500. In some cases, sleeving the strap portion of a loop in plastic (e.g., plastic tubing) may increase the durability of the strap portion of the loop, may allow a linking device to slide more easily along a strap portion of the loop, etc. Other sleeving materials (such as, e.g., rubber, metal) which may provide functions of increased durability and/or reduced friction to a sliding linking device are also contemplated. One or all of the strap portions of any loop of an animal control apparatus may be so sleeved, and it is not necessary for the materials used in the various sleevings of an animal control apparatus to be uniform across separate loops. It is further anticipated that one or both of the sleevings 522, 524 as described may be removable (e.g., to change the function of a loop and/or to facilitate cleaning of one or more of the sleevings 522, 524 and the animal control apparatus 500). Sleevings similar to those described here in relation to the animal control apparatus 500 may similarly be arranged for (and provide similar benefits to) other animal control apparatuses discussed herein (including the embodiments of an animal control apparatus using only a single strap).

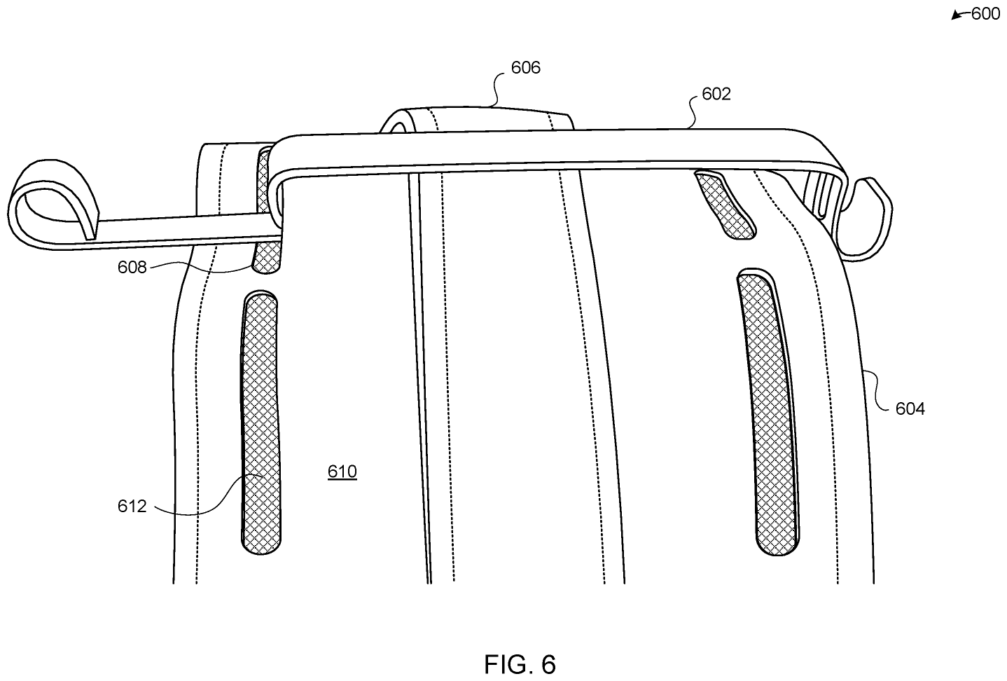

FIG. 6 illustrates a portion of an animal control apparatus 600 in use with an associated tactical mount 602, in accordance with one embodiment. The animal control apparatus 600 includes a belt 604 and a strap 606. The belt 604 of the animal control apparatus 600 includes a slot 608 accessible at a first belt layer 610 and through which a second belt layer 612 can be viewed. As illustrated, the tactical mount 602 has been clipped through the slot 608, with the clip being engaged beneath the first belt layer 610 of the belt 604, causing the tactical mount 602 to now be carried at the midsection of the user along with the animal control apparatus 600. It is anticipated that other devices may be attached at the slot 608 of the animal control apparatus 600 that may be useful to have when a user of the animal control apparatus 600 is out of doors (e.g., a cellular phone, hiking/camping equipment, etc.). It is anticipated that such device may be attached at the slot 608 via clipping, being strung through the slot 608 and another slot of the belt 604, or in another fashion.

Although FIG. 6. Illustrates that the slot 608 passes through only the first belt layer 610 of the belt 604, it is anticipated that in other embodiments the slot 608 may pass through multiple and/or all of the layers of the belt 604. As shown, depending on the slot chosen and how the device situates relative to the rest of the animal control apparatus 600 when interfaced with the chosen slot, there may be some interference between the device and, e.g., the strap 606 of the animal control apparatus 600. A user of the animal control apparatus 600 will be able to strategically place the device in a slot such that this interference is avoided or minimized, should that be desired.

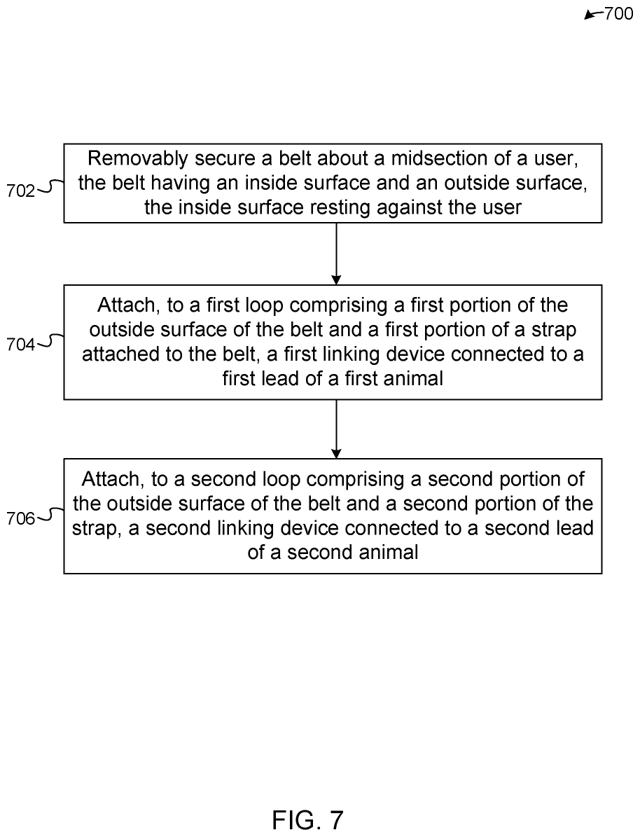

FIG. 7 illustrates a method 700 for using an animal control apparatus, according to an embodiment. The method 700 includes removably securing 702 a belt about a midsection of a user, the belt having an inside surface and an outside surface, the inside surface resting against the user. The belt may be a belt of the animal control apparatus being used, according to embodiments thereof disclosed herein.

The method 700 further includes attaching 704, to a first loop comprising a first portion of the outside surface of the belt and a first portion of a strap attached to the belt, a first linking device connected to a first lead of a first animal. The strap may be attached to the belt at a plurality of attachment locations on the outside surface of the belt. The first linking device may be configured to slide along the first portion of the strap between a pair of attachment locations of the plurality of attachment locations that is associated with the first loop according to a movement of the first animal parallel to the extension of the first portion of the strap along the first portion of the outside surface of the belt.

The method 700 further includes attaching 706, to a second loop comprising a second portion of the outside surface of the belt and a second portion of the strap, a second linking device connected to a second lead of a second animal. The second linking device may be configured to slide along the second portion of the strap between a pair of attachment locations of the plurality of attachment locations that is associated with the second loop according to a movement of the second animal parallel to the extension of the second portion of the strap along the second portion of the outside surface of the belt. The second pair of attachment locations may share a common attachment location with the first pair of attachment locations.

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced, are not to be construed as a critical, required, or essential feature or element. The scope of the present invention should, therefore, be determined by the following claims.

What is claimed is:

1. An animal control apparatus, comprising:
a belt to be removably secured about a midsection of a user, the belt having an inside surface and an outside surface, the inside surface configured to rest against the user; and
a strap attached to the belt at first and second attachment locations on the outside surface of the belt such that a first portion of the strap extends along a first portion of the outside surface of the belt between the first and second attachment locations, the first attachment location being spaced apart from the second attachment location to create a first loop between the first portion of the outside surface of the belt and the first portion of the strap;
wherein a distance between the first and second attachment locations is more than one-quarter and less than one-half of the length of the belt;
wherein the first loop is configured to receive a first linking device connected to a lead of a first animal, the first linking device to slide along the first portion of the strap between the first and second attachment locations according to a movement of the first animal parallel to the extension of the first portion of the strap; and
wherein the first loop is further configured to apply a stationary force on the first linking device relative to the movement of the first animal perpendicular to the extension of the first portion of the strap along the first portion of the outside surface of the belt when the belt is removably secured about the midsection of the user.

2. The animal control apparatus of claim 1, wherein the strap is further attached to the belt at third and fourth attachment locations on the outside surface of the belt such that a second portion of the strap extends along a second portion of the outside surface of the belt between the third and fourth attachment locations, the third attachment location being spaced apart from the fourth attachment location to create a second loop between the second portion of the outside surface of the belt and the second portion of the strap;
wherein the second loop is configured to receive a second linking device connected to a lead of a second animal, the second linking device to slide along the second portion of the strap between the third and fourth attachment locations according to the movement of the second animal parallel to the extension of the second portion of the strap; and
wherein the second loop is further configured to apply a stationary force on the second linking device relative to the movement of the second animal perpendicular to the extension of the second portion of the strap along the second portion of the outside surface of the belt when the belt is removably secured about the midsection of the user.

3. The animal control apparatus of claim 2, wherein the first portion of the strap and the second portion of the strap are each at least partially covered in a sleeving.

4. The animal control apparatus of claim 3, wherein the sleeving covering the first portion of the strap is removable.

5. The animal control apparatus of claim 3, wherein the sleeving covering the first portion of the strap is plastic tubing.

6. The animal control apparatus of claim 2, wherein:
a third portion of the strap extends along a third portion of the outside surface of the belt between the second and third attachment locations, the second attachment location being spaced apart from the third attachment location to create a third loop between the third portion of the outside surface of the belt and the third portion of the strap; and wherein the distance between the second and third attachment locations is less than one-half of the length of the belt.

7. The animal control apparatus of claim 1, wherein the belt comprises a memory foam layer that is positioned against the midsection of the user when the belt is removably secured about the midsection of the user.

8. The animal control apparatus of claim 7, wherein the memory foam layer comprises a parallel venting feature.

9. The animal control apparatus of claim 1, wherein a width of the strap is more than one-third of a width of the belt.

10. The animal control apparatus of claim 1, wherein the belt further includes a slot accessible at the outside surface of the belt.

11. The animal control apparatus of claim 10, wherein the slot is configured to receive a tactical mount.

12. The animal control apparatus of claim 1, wherein the belt is constructed of multiple layers.

13. The animal control apparatus of claim 1, wherein the strap is constructed of multiple layers.

14. The animal control apparatus of claim 1, wherein the belt is removably securable to the midsection of the user via a buckle connected to the strap.

15. An animal control apparatus, comprising:
a belt to be removably secured about a midsection of a user, the belt having an inside surface and an outside surface, the inside surface configured to rest against the user;
a first strap attached to the belt at first pair of attachment locations on the outside surface of the belt such that a portion of the first strap extends along a first portion of the outside surface of the belt between the first pair of attachment locations, the first pair of attachment locations being spaced apart to create a first loop between the first portion of the outside surface of the belt and the portion of the first strap; and
a second strap attached to the belt at a second pair of attachment locations on the outside surface of the belt such that a portion of the second strap extends along a second portion of the outside surface of the belt between the second pair of attachment locations, the second pair of attachment locations being spaced apart to create a second loop between the second portion of the outside surface of the belt and the portion of the second strap;
wherein a distance between the first pair of attachment locations is more than one-quarter and less than one-half of the length of the belt;
wherein the first loop is configured to receive a first linking device connected to a lead of a first animal, the first linking device to slide along the portion of the first strap between the first pair of attachment locations according to a movement of the first animal parallel to the extension of the portion of the first strap; and
wherein the first loop is further configured to apply a stationary force on the first linking device relative to the movement of the first animal perpendicular to the extension of the portion of the first strap along the first portion of the outside surface of the belt when the belt is removably secured about the midsection of the user.

16. The animal control apparatus of claim 15, wherein:
the distance between the second pair of attachment locations is more than one-quarter and less than one-half of the length of the belt;
the second loop is configured to receive a second linking device connected to a lead of a second animal, the second linking device to slide along the portion of the second strap between the second pair of attachment locations according to the movement of the second animal parallel to the extension of the portion of the second strap; and
the second loop is further configured to apply a stationary force on the second linking device relative to the movement of the second animal perpendicular to the extension of the portion of the second strap along the second portion of the outside surface of the belt when the belt is removably secured about the midsection of the user.

17. The animal control apparatus of claim 15, wherein at least part of the portion of the first strap is covered in sleeving.

18. The animal control apparatus of claim 15, wherein the first pair of attachment locations and the second pair of attachment locations share a common attachment location.

19. An animal control apparatus, comprising:
a belt to be removably secured about a midsection of a user, the belt having an inside surface and an outside surface, the inside surface configured to rest against the user;
a strap attached to the belt at a plurality of attachment locations on the outside surface of the belt such that:
a first portion of the strap extends along a first portion of the outside surface of the belt between a first pair of attachment locations of the plurality of attachment locations, the first pair of attachment locations spaced apart to create a first loop between the first portion of the outside surface of the belt and the first portion of the strap; and
a second portion of the strap extends along a second portion of the outside surface of the belt between a second pair of attachment locations of the plurality of attachment locations, the second pair of attachment locations spaced apart to create a second loop between the second portion of the outside surface of the belt and the second portion of the strap;
wherein the first loop is configured to receive a first linking device, the first linking device to slide along the first portion of the strap between the first pair of attachment locations according to a movement of the first animal parallel to the extension of the first portion of the strap; and
wherein the second loop is configured to receive a second linking device, the second linking device to slide along the second portion of the strap between the second pair of attachment locations according to a movement of the second animal parallel to the extension of the second portion of the strap.

20. The animal control apparatus of claim 19, wherein the first pair of attachment locations and the second pair of attachment locations share a common attachment location.
